(19) United States
(12) Patent Application Publication
(10) Pub. No.: US 2026/0361248 A1
(43) Pub. Date: Nov. 12, 2026

(54) Operating method for a brushless direct current motor motor of an electric power tool

(71) Applicant: Hilti Aktiengesellschaft, Schaan (LI)

(72) Inventors: Markus SCHERBAUM, Gennach (DE); Justus FREISCHLE, Landsberg (DE)

(21) Appl. No.: 19/100,271

(22) PCT Filed: Jul. 28, 2023
(86) PCT No.: PCT/EP2023/071057

§ 371 Date: Jan. 31, 2025

(30) Foreign Application Priority Data
Aug. 8, 2022 (EP) 22189188.0

(51) Int. Cl. H02P 21/36; H02K 7/14; H02P 21/04; H02P 21/22

(52) U.S. Cl. CPC H02P 21/36; H02K 7/145; H02P 21/04; H02P 21/22; H02P 2207/05

(57) ABSTRACT

A method for operating a drive unit of a machine tool, wherein the drive unit has a brushless DC motor and an intermediate circuit connected upstream of the DC motor, wherein the DC motor in a working mode is controlled by a speed controller and is operated at a nominal speed, and wherein the method has an braking mode in which the DC motor is braked to a braking speed which is lower than the nominal speed, wherein the DC motor in the braking mode is controlled with a reference variable which is based on an intermediate-circuit voltage of the intermediate circuit.

The present invention relates to a method for operating a drive unit of a machine tool, wherein the drive unit has a brushless DC motor (BLDC motor) and an intermediate circuit connected upstream of the BLDC motor. The BLDC motor is controlled in a working mode by a speed controller and is operated at a nominal speed. The method further comprises a braking mode in which the BLDC motor is braked to a braking speed lower than the nominal speed.

### BACKGROUND

Methods of this kind are known in principle from the prior art.

### SUMMARY OF THE INVENTION

In order to brake a BLDC motor quickly to a standstill, the rotational energy stored in the BLDC motor and in the driven mechanical overall system must be extracted or converted.

It is often not technically possible to feed the rotational energy back into the electrical voltage source, or the instantaneous power and duration of the feed-back energy are limited, so that a typically required fast braking time cannot be achieved.

In so-called short-circuit braking, the BLDC motor is short-circuited at its terminals. This can be achieved by switching on all low-side power semiconductors of the motor inverter simultaneously. An initially higher initial short-circuit current is formed, which decays to a continuous short-circuit current. The short-circuit current generates a braking torque in the motor. Another braking mode of the prior art can be provided using a brake chopper with braking resistor. Here, the BLDC motor is braked in a controlled manner, thereby becoming a generator. The energy output is fed back into the intermediate circuit, causing the intermediate-circuit voltage to rise. The brake chopper with braking resistor periodically switches a resistor to the intermediate circuit via a power semiconductor switch in order to convert the energy in the braking resistor into heat.

It is an object of the present invention to provide a method for operating a drive unit of a machine tool that provides the basis for a simple and fast braking mode.

The present invention provides controlling the BLDC motor in braking mode with a reference variable based on an intermediate-circuit voltage of the intermediate circuit. It has been found to be advantageous if the BLDC motor is controlled in braking mode with the reference variable in such a way that a generator power fed back into the intermediate circuit during braking of the BLDC motor is equal to a resistive power loss converted in the BLDC motor.

The invention includes the realization that in the case of short-circuit braking mentioned at the outset, typically no influence can be exerted on the braking torque or the braking time. In particular, the level of the short-circuit current is determined only by motor parameters. The electronics must also be able to carry the initially higher initial short-circuit current. The solution known from the prior art based on a brake chopper with braking resistor does have more degrees of freedom with regard to achieving a desired braking torque or braking time. However, additional hardware components (MOSFET/IGBT, gate driver, a discrete braking resistor, connecting wires) are necessary here, which require more installation space and incur additional costs. The braking resistor in particular must be specified for high pulse powers and contributes significantly to installation space and costs.

In contrast to this, the method according to the invention is based on the idea of converting the braking energy as ohmic losses in the BLDC motor itself in braking mode.

The main advantage of the invention is that a fast braking process is favored with the best possible utilization of the power electronics/inverter without additional components. The desired braking behavior can be precisely defined by means of parameters in the braking method described. The minimum possible braking time is dependent on the current-carrying capacity of the inverter of the power electronics, but faster braking processes are possible simply by corresponding scaling of the inverter to higher currents.

In a particularly preferred embodiment, a controller is used in braking mode, the control input variable of which is a control deviation of the intermediate circuit-voltage and/or the control output variable of which is the reference variable.

In another particularly preferred embodiment, the brushless DC motor is controlled by means of vector control and the reference variable represents a current space vector angle. In another particularly preferred embodiment, the brushless DC motor is controlled by means of block commutation and the reference variable represents a commutation angle.

It has been found to be advantageous if the motor current amplitude in braking mode is constant up to a lower braking speed threshold that is greater than zero. The lower braking speed threshold can be 100 rpm, for example. Advantageously, the motor current amplitude in braking mode may correspond to a current-carrying capacity of an inverter associated with the DC motor.

In another particularly preferred embodiment, the DC motor is controlled in braking mode with the reference variable in such a way that a generator power fed back into the intermediate circuit during braking of the DC motor is equal to a resistive power loss converted in the DC motor.

It has been found to be advantageous if a switching block is used for switching between working mode and braking mode within the scope of the method. In another particularly preferred embodiment, the intermediate-circuit voltage is determined on the basis of the voltages induced in the stator windings of the brushless DC motor caused by the counter-electromotive force. The intermediate-circuit voltage can also be measured directly.

It has been found to be advantageous if the brushless DC motor is braked completely in braking mode, i.e., down to speed 0.

The present invention also provides a drive unit for a machine tool, wherein the drive unit has a brushless DC motor and an intermediate circuit connected upstream of the DC motor, wherein the drive unit is designed to control the DC motor in a working mode by means of a speed controller and to be able to operate it at a nominal speed, and the drive unit is designed to be able to operate the DC motor in a braking mode in which the DC motor is braked to a braking speed which is lower than the nominal speed. According to the invention, the drive unit is designed to control the DC motor in the braking mode on the basis of a motor current amplitude and a reference variable that is dependent on an intermediate-circuit voltage of the intermediate circuit. It has proved advantageous if a controller is used in braking mode, the control input variable of is a control deviation of the intermediate-circuit voltage and/or the control output variable of which is the reference variable.

The drive unit is preferably part of a machine tool, in particular a hand-held machine tool.

Further advantages will become apparent from the following description of the figures. Particularly preferred exemplary embodiments of the present invention are illustrated in the figures. The figures, the description, and the claims contain numerous features in combination. A person skilled in the art will expediently also consider the features individually and combine them to form sensible further combinations.

### BRIEF DESCRIPTION OF THE DRAWINGS

Identical and functionally identical components are denoted by the same reference signs in the figures, in which:

FIG. 1 shows a block diagram for field-oriented control of a BLDC motor;

FIG. 2 shows motor characteristics of a BLDC motor in the rotor-fixed d/q coordinate system;

FIG. 3 shows the current space vector angle over time in the method according to FIG. 1; and

FIG. 4 shows a block diagram for block-commutated control of a BLDC motor.

### DETAILED DESCRIPTION

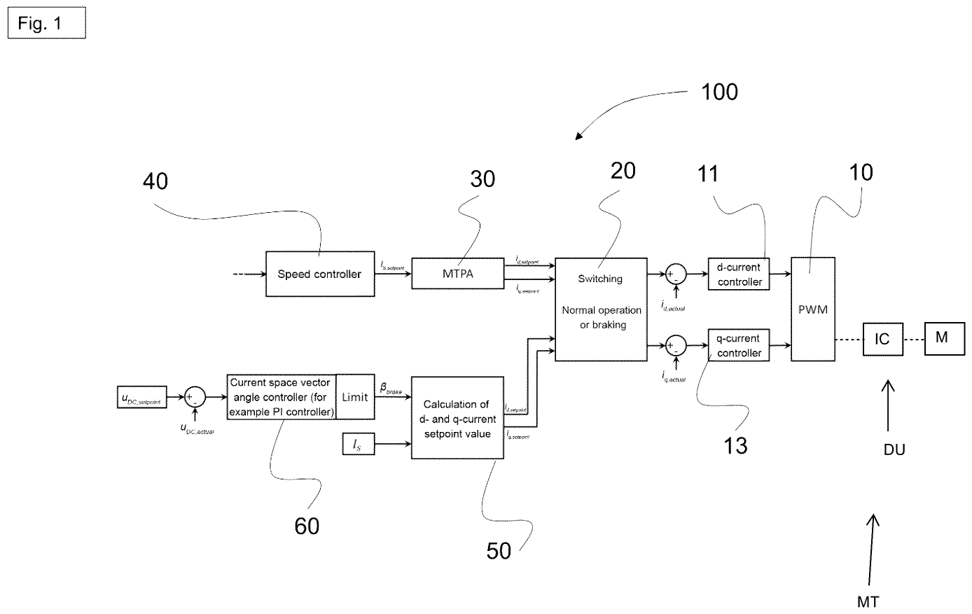

In the following, a preferred embodiment of the method is described on the basis of a field-oriented motor control with a rotor-fixed d/q coordinate system (Park transformation). For this purpose, FIG. 1 shows a block diagram 100 with which a drive unit DU shown here solely schematically which has a brushless DC motor (BLDC motor) M shown solely schematically and an intermediate circuit IC also shown solely schematically connected upstream of the BLDC motor, can be controlled.

The block diagram 100 has a PWM block 10 for pulse-width modulated control of the BLDC motor. Input variables for the PWM block 10 are provided by a d-current controller 11 and a q-current controller 13. Upstream of the d-current controller 11 and the q-current controller 13 is a common switching block 20 for switching between a working mode and a braking mode of the method.

An MTPA (Maximum Torque per Ampere) block 30 is connected upstream of the switching block 20 in an “upper” path and outputs a d setpoint current and a q setpoint current. The MTPA block 30 in turn receives its setpoint current from a speed controller 40. This path represents the operating mode in which the BLDC motor is controlled by speed controller 40 and operated at a nominal speed. The nominal speed can, for example, be specified by an operating knob of a machine tool MT indicated schematically.

The block diagram 100 further has a “lower” path, which represents a preferred variation of the braking mode. In the braking mode, the BLDC motor is braked to a braking speed that is less than the nominal speed. In this path, a calculation block 40 is connected upstream of the switching block 20, which outputs a d setpoint current and a q setpoint current to the switching block 20.

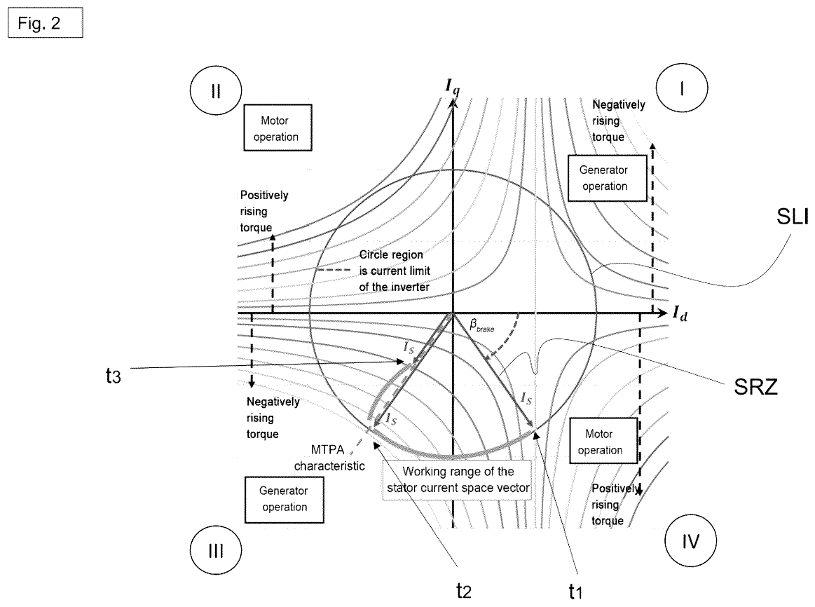

The calculation block 50 has, as input variables, a motor current amplitude I_{S} (cf. FIG. 2 magnitude of the stator current space vector SRZ) and a reference variable β_{brake}, which indicates the displacement of the stator current space vector relative to the d-axis (cf. FIG. 2). The reference variable β_{brake} is control output variable of a current space vector angle controller 60. The reference variable β_{brake} may be limited downwardly and/or upwardly in a limiter of the current space vector angle controller 60. The control input variable of the current space vector angle controller 60, which is designed as a PI controller by way of example, is a control deviation between specified setpoint intermediate-circuit voltage U_{DC,setpoint} and an actual intermediate-circuit voltage U_{DC,actual} of the intermediate circuit connected upstream of the BLDC motor (not shown here). Thus, the reference variable β_{brake} depends on a intermediate-circuit voltage of the intermediate circuit in a controlled manner. The motor current amplitude I_{S} as input variable for the calculation block 50 is constant in braking mode in the present exemplary embodiment and corresponds by way of example to a current-carrying capacity of an inverter assigned to the BLDC motor.

The aforementioned switching block 20 thus determines whether the d-current controller 11 and the q-current controller 13 receive their setpoint values from the speed controller 40 with MTPA block 30 or whether the setpoint values are provided by the braking method represented in the “lower” path. A switch request signal for the switching block 20 can be triggered, for example, by a “release” of an operating button of a machine tool.

To further explain the method, FIG. 2 shows motor characteristics of an exemplary BLDC motor in the rotor-fixed d/q coordinate system with four quadrants I to IV. (The rotor angle required for the transformation can be determined, for example, by Hall sensors or by evaluating the EMF forces at the stator windings). In the first quadrant I, the d-current and q-current are positive. In the third quadrant III, the d-current and the q-current are negative. In the second quadrant II, the d-current is negative and the q-current is positive. In the fourth quadrant IV, the d-current is positive and the q-current is negative.

The stator current space vector SRZ has the motor current amplitude Is as its magnitude. The current space vector angle β_{brake} indicates the displacement of the stator current space vector relative to the d-axis. The current space vector angle β_{brake} corresponds to the reference variable β_{brake} in FIG. 1. The current space vector angle β_{brake} is calculated by a controller, for example a PI controller of which the control input variable is the intermediate-circuit voltage u_{DC} as shown in FIG. 1.

As mentioned above, the invention is based on the concept of converting the braking energy as ohmic losses in the motor itself. For this purpose, the ohmic losses in the BLDC motor (P_{V}=R·I²) are advantageously balanced with the power regenerated by the BLDC motor during the braking process (P_{M}=M_{brake}·ω_{mech}) in order to avoid an uncontrolled increase in the intermediate-circuit voltage. The braking torque of the motor M_{brake}s can be adjusted while keeping the motor current amplitude I_{S} constant by changing the current space vector angle β_{brake}. The motor current amplitude I_{S} is selected in braking mode so that current-measuring ranges and the current-carrying capacity of the inverter are not exceeded. The current limit SLI of the inverter is shown as a circle in FIG. 2. Preferably, the motor current amplitude I_{S} is kept constant to make the best possible use of the inverter and to achieve the shortest braking time.

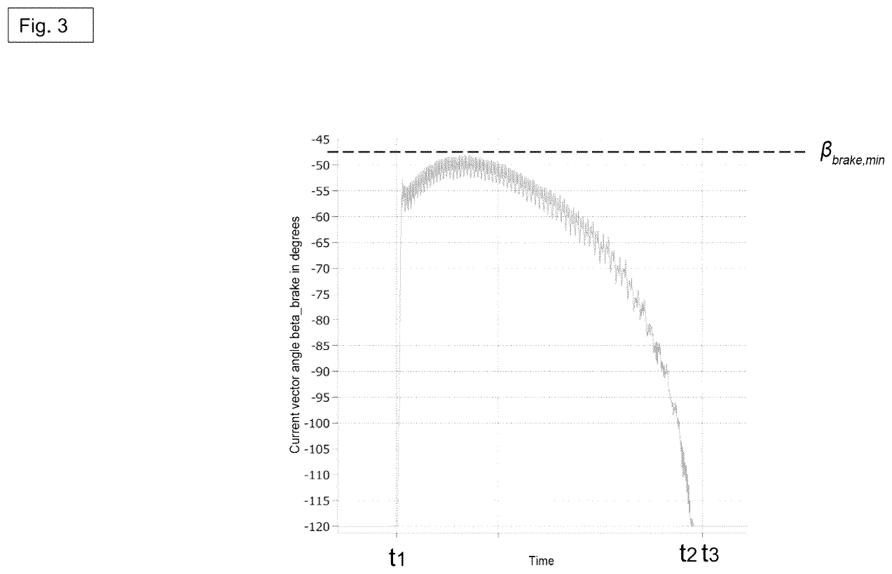

An angle β_{brake}=0 corresponds to a stator current space vector which lies on the positive d-axis. With increasing current space vector angle β_{brake} a negative q-current component is obtained with a simultaneously decreasing positive d-current. It should be noted that the current space vector angle β_{brake} should not fall below a minimum value, since generator braking operation would change to motor operation there. This limit is dependent on the BLDC motor used. The manipulated variable of the current controller is therefore limited to a minimum permissible value β_{brake,min} which, as an example, is about 47° (cf. FIG. 3). With β_{brake}=90° the quadrant is finally changed until the MTPA (Maximum Torque per Ampere) operating point is reached with negative d- and q-current.

In FIG. 2, the time at the transition from working mode to braking mode is denoted by t₁. The current space vector angle β_{brake} is, for example, about 57° (see FIG. 3). In the course of the braking process, the current space vector angle β_{brake} moves in its working range in the direction of larger angles until a time t₂ with low braking speed. The current space vector angle β_{brake} is now about 117°, by way of example. At such a low braking speed, the ohmic losses can exceed the generator-generated power, so that the difference would have to be covered by the voltage source. If no power is to be drawn from the voltage source, the motor current amplitude I_{S} of the stator current space vector SRZ can optionally be shortened along the MTPA characteristic. At time t₃, the BLDC motor is just before it comes to a standstill. A typical braking process can, for example, have the time curve of the current space vector angle β_{brake} shown in FIG. 3. In the course of the braking process, the angular frequency of the BLDC motor is reduced and, accordingly, the angular frequency of the rotor-fixed d/q coordinate system in which the BLDC motor is controlled by means of the stator current space vector SRZ.

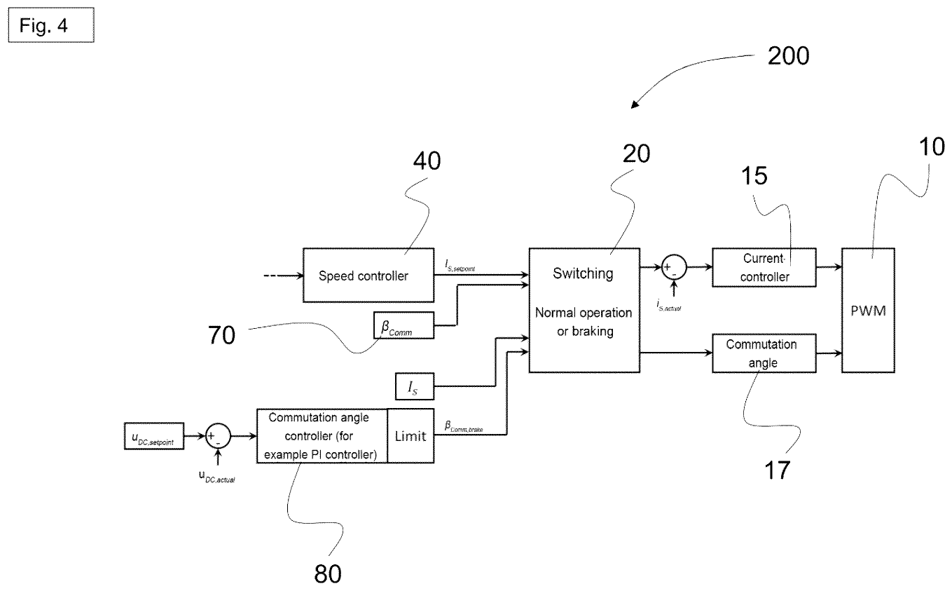

FIG. 4 shows another exemplary embodiment of the method using block commutation. For this purpose, FIG. 4 shows a block diagram 200 with which a drive unit, not shown here, which has a brushless DC motor (BLDC motor) and an intermediate circuit connected upstream of the BLDC motor, can be controlled.

The block diagram 200 has a PWM block 10 for pulse-width modulated control of the BLDC motor. Input variables for the PWM block 10 are provided by a current controller 15 and an angle preset block 17. A common switching block 20 for switching between a working mode and a braking mode of the method is connected upstream of the current controller 15 and the angle preset block 17.

A speed controller 40 and a constant angle block 70 for outputting a constant commutation angle are connected upstream of the switching block 20 in an “upper” path. This path represents the operating mode in which the BLDC motor is controlled by speed controller 40 and operated at a nominal speed. The nominal speed can, for example, be specified by an operating knob of a machine tool.

The block diagram 200 further has a “lower” path, which represents a preferred variation of the braking mode. In the braking mode, the BLDC motor is braked to a braking speed that is less than the nominal speed. In this path, a commutation angle controller 80, exemplified as a PI controller, is connected upstream of the switching block 20. The commutation angle controller 80 outputs a reference variable β_{Commbrake} to the switching block 20, wherein a control input variable of the commutation angle controller 80 (as in the exemplary embodiment of FIG. 1) is a control deviation between specified setpoint intermediate-circuit voltage U_{DC,setpoint} and an actual intermediate-circuit voltage U_{DC,actual} of the intermediate circuit connected upstream of the BLDC motor (not shown here). Thus, the reference variable β_{Commbrake} depends on an intermediate-circuit voltage of the intermediate circuit in a controlled manner. The motor current amplitude I_{S} as input variable for the switching block 20 is constant in braking mode in the present exemplary embodiment and corresponds by way of example to a current-carrying capacity of an inverter assigned to the BLDC motor. The switching block 20 determines here whether a current controller amplitude with constant commutation angles is provided by the speed controller (operating mode) or constant current controller setpoint (motor current amplitude) with variable commutation angles (braking mode) is used.

### LIST OF REFERENCE SIGNS

10 PWM block
11 d-current controller
13 q-current controller
15 current controller (block commutation)
17 angle preset block (block commutation)
20 switching block
30 MTPA block
40 speed controller
50 calculation block
60 current space vector angle controller
70 constant angle block
80 commutation angle controller
100 block diagram for field-oriented motor control
200 block diagram for block-commutated motor control
β_{brake} reference variable (vector control)
β_{Commbrake} reference variable (block commutation)
I_{D}, I_{q} motor currents in the d/q coordinate system
I_{S} motor current amplitude
U_{DC,actual} actual intermediate-circuit voltage
U_{DC,setpoint} setpoint intermediate-circuit voltage
SLI current limit of the inverter
SRZ stator current space vector
I . . . IV quadrants

What is claimed is:

1-12. (canceled)

13: A method for operating a drive unit of a machine tool, the drive unit having a brushless DC motor and an intermediate circuit connected upstream of the DC motor, the DC motor in a working mode being controlled by a speed controller and operated at a nominal speed, the method comprising:
braking in a braking mode the DC motor to a braking speed lower than the nominal speed, the DC motor in the braking mode being controlled on the basis of a motor current amplitude and a reference variable, the reference variable dependent on an intermediate-circuit voltage of the intermediate circuit.

14: The method recited in claim 13 wherein in the braking mode a controller is used, a control input variable of the controller being an intermediate-circuit voltage or a control deviation of the intermediate circuit-voltage.

15: The method recited in claim 14 wherein in the braking mode a controller is used, a control output variable of the controller being the reference variable for control of the DC motor.

16: The method recited in claim 13 wherein in the braking mode a controller is used, a control output variable of the controller being the reference variable for control of the DC motor.

17: The method recited in claim 13 wherein the motor current amplitude in braking mode is constant up to a lower braking speed threshold that is greater than zero.

18: The method as recited in claim 17 wherein the motor current amplitude in the braking mode corresponds to a current-carrying capacity of an inverter associated with the DC motor.

19: The method recited in claim 13 wherein the DC motor is controlled in braking mode with the reference variable in such a way that a generator power fed back into the intermediate circuit during braking of the DC motor is equal to a resistive power loss converted in the DC motor.

20: The method recited in claim 13 wherein a switching block is used for switching between working mode and braking mode within the scope of the method.

21: The method recited in claim 13 wherein the intermediate-circuit voltage is determined on the basis of voltages induced in stator windings of the brushless DC motor caused by the counter-electromotive force.

22: The method recited in claim 13 wherein the brushless DC motor is braked completely in braking mode.

23: The method recited in claim 13 wherein the brushless DC motor is controlled via vector control and the reference variable represents a current space vector angle.

24: The method recited in claim 13 wherein the brushless DC motor is controlled via block commutation and the reference variable represents a commutation angle.

25: A drive unit for a machine tool, the drive unit comprising:
a brushless DC motor and an intermediate circuit connected upstream of the DC motor, the drive unit designed to control the DC motor in a working mode via a speed controller and to be able to operate the DC motor at a nominal speed, and the drive unit is designed to be able to operate the DC motor in a braking mode, the DC motor being braked in the braking mode to a braking speed lower than the nominal speed,
the drive unit being designed to control the DC motor in the braking mode on the basis of a motor current amplitude and a reference variable dependent on an intermediate-circuit voltage of the intermediate circuit.

26: A machine tool comprising the drive unit as claimed in recited in claim 25.

27: The machine tool as recited in claim 16 wherein the machine tool is a hand-held machine tool.
